(19) United States
(12) Patent Application Publication
(10) Pub. No.: US 2026/0297365 A1
(43) Pub. Date: Oct. 1, 2026

(54) A STRETCHABLE CONDUCTIVE INK

(71) Applicant: Agency for Science, Technology and Research, Singapore (SG)

(72) Inventors: Wei Peng GOH, Singapore (SG); Changyun JIANG, Singapore (SG); Yuxin LIU, Singapore (SG); Ruth Theresia ARWANI, Singapore (SG); Chong Li Sherwin TAN, Singapore (SG); Yong YU, Singapore (SG); Xinting ZHENG, Singapore (SG); Le YANG, Singapore (SG)

(73) Assignee: Agency for Science, Technology and Research, Singapore (SG)

(21) Appl. No.: 19/476,049

(22) PCT Filed: Apr. 18, 2024
(86) PCT No.: PCT/SG2024/050253

§ 371 Date: Oct. 16, 2025

(30) Foreign Application Priority Data
Apr. 18, 2023 (SG) 10202301074Q

(51) Int. Cl. C09D 11/52; C09D 11/037; C09D 11/102; G01N 27/30

(52) U.S. Cl. CPC C09D 11/52; C09D 11/037; C09D 11/102; G01N 27/308

(57) ABSTRACT

There is provided a stretchable conductive ink comprising: a carbon-based material; a conducting polymer; a viscoelastic polymer; and an amphiphilic polymer, wherein the conductive ink is hydrophilic. There is also provided an electrode for an electrochemical sensor comprising a substrate and the conductive ink.

### TECHNICAL FIELD

The present invention relates to a stretchable conductive ink.

### BACKGROUND

Printed carbon electrodes are widely used for electrochemical sensing due to their faradaic properties, low cost, non-toxicity and compatibility for electrochemical processes. With the advent of wearables for healthcare, imparting stretchability to electrochemical sensors is crucial for on-skin conformance.

Currently, electrodes are infused with carbon nanotubes (CNTs) to impart stretchability. However, printing the electrodes is challenging due to the high aspect ratio of CNT strands. Further, carbon is hydrophobic and therefore, functionalising electrodes is also challenging as further functionalisation steps may be required for the preparation of the electrodes.

There is therefore a need for an improved electrode.

### SUMMARY OF THE INVENTION

The present invention seeks to address these problems, and/or to provide an improved and stretchable and hydrophilic electrode.

According to a first aspect, the present invention provides a stretchable conductive ink comprising:
a carbon-based material;
a conducting polymer;
a viscoelastic polymer; and
an amphiphilic polymer,
   wherein the conductive ink is hydrophilic.

According to a particular aspect, the conductive ink may be for use in making an electrode.

The carbon-based material may be any suitable material. According to a particular aspect, the carbon-based material may comprise, but is not limited to, graphite.

The conducting polymer may be any suitable polymer. For example, the conducting polymer may comprise a conjugated polymer. In particular, the conducting polymer may be, but not limited to: poly(3,4-ethylenedioxythiophene) polystyrene sulfonate (PEDOT:PSS).

The viscoelastic polymer may be any suitable polymer. For example, the viscoelastic polymer may comprise a viscoelastic secondary polymer. In particular, the viscoelastic polymer may be, but is not limited to: waterborne polyurethane.

The amphiphilic polymer may be any suitable polymer. For example, the amphiphilic polymer may comprise an amphiphilic block copolymer. In particular, the amphiphilic block copolymer may comprise, but is not limited to, a triblock copolymer. According to a particular aspect, the amphiphilic polymer may be, but is not limited to: a poloxamer.

The conductive ink may further comprise a dopant. In particular the dopant may improve the conductivity of the conductive ink. The dopant may be any suitable dopant. For example, the dopant may be a polar solvent, organic acid, inorganic acid, polyol, surfactant, conductive polymer, ionic liquid, or a mixture thereof. In particular, the dopant may comprise, but is not limited to, dimethyl sulfoxide (DMSO).

The conductive ink may further comprise a redox mediator. In particular, the redox mediator may be, but not limited to, Prussian Blue.

According to a second aspect, there is provided an electrode for an electrochemical sensor comprising: a substrate; and a conductive ink according to the first aspect provided on a surface of the substrate. The electrode may be a stretchable electrode.

The conductive ink may be provided on the surface of the substrate by any suitable means. In particular, the conductive ink may be screen-printed on a surface of the substrate.

The substrate may be any suitable substrate. According to a particular aspect, the substrate may be elastomeric.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows the changes in resistance of the conductive ink according to various embodiments;

FIG. 2 shows the use of an electrode according to various embodiments as glucose sensors;

FIG. 3 shows the sensitivity of the glucose sensors referred to in FIG. 2; and

FIG. 4A shows the scanning electron microscope (SEM) image of a cross-section of an electrode according to one embodiment and FIG. 4B shows the SEM of a cross-section of a commercially available electrode.

### DETAILED DESCRIPTION

As explained above, there is a need for an improved electrode.

In general terms, the present invention provides a stretchable conductive ink which is hydrophilic. There is also provided an electrode which comprises the conductive ink. In particular, the conductive ink does not comprise any toxic compounds and may therefore be suitable for on-skin healthcare applications and uses. Further, in view of the hydrophilicity of the conductive ink, and therefore the electrode on which the conductive ink is applied, bodily fluids can be easily absorbed. This makes the electrode more suitable for use as electrochemical sensors in skin wearable devices.

According to a first aspect, the present invention provides a stretchable conductive ink comprising:
a carbon-based material;
a conducting polymer;
a viscoelastic polymer; and
an amphiphilic polymer,
   wherein the conductive ink is hydrophilic.

According to a particular aspect, the conductive ink may be for use in making an electrode.

The carbon-based material may be any suitable material. The carbon-based material may provide the base structure of the conductive ink and enables faradaic current when the conductive ink is applied to an electrode.

For example, the carbon-based material may comprise, but is not limited to, graphite, carbon black, glassy carbon, carbon nanoparticles, graphene, fullerene, amorphous carbon, carbon nanotubes (CNTs), or a mixture thereof. In particular, the CNTs may be CNTs with a suitable dimension. For example, the CNTs may comprise a dimension of not more than 30% of the opening of a screen-printing stencil. Even more in particular, the carbon-based material may be graphite.

The conducting polymer may be any suitable polymer. The conducting polymer may function as a conducting binder and may provide pathways for electrolyte and therefore further boost faradaic current when the conductive ink is applied to an electrode.

For example, the conducting polymer may comprise a conjugated polymer. In particular, the conducting polymer may be, but not limited to: poly(3,4-ethylenedioxythiophene) polystyrene sulfonate (PEDOT:PSS), polyacetylene, polyaniline, polypyrrole, polythiophene, poly(para-phenylene), poly(phenylenevinylene), polyfuran, or a mixture thereof. Even more in particular, the conducting polymer may be PEDOT:PSS.

The viscoelastic polymer may be any suitable polymer. The viscoelastic polymer may be any suitable polymer which may impart stretchability to the conductive ink. For example, the viscoelastic polymer may comprise a viscoelastic secondary polymer. In particular, the viscoelastic polymer may be, but is not limited to: waterborne polyurethane (WPU), polyethylene (PE), polypropylene (PP), polyvinyl chloride (PVC), polyurethane (PU), polystyrene (PS), polyethylene terephthalate (PET), poly(methyl methacrylate) (PMMA), polyvinyl acetate (PVA), polyisoprene, polybutadiene, natural rubber, styrene butadiene rubber (SBR), nitrile rubber (NBR), ethylene propylene diene monomer (EPDM), chloroprene rubber (Neoprene), butyl rubber (IIR), silicone rubber, fluoroelastomers (FKM), or a mixture thereof. Even more in particular, the viscoelastic polymer may be WPU.

The amphiphilic polymer may be any suitable polymer. The amphiphilic polymer may render hydrophilicity to the conductive ink. The amphiphilic polymer may comprise an amphiphilic block copolymer. In particular, the amphiphilic block copolymer may comprise, but is not limited to, a triblock copolymer. For example, the amphiphilic polymer may comprise, but is not limited to, a poloxamer, polyethylene glycol (PEG), poly(lactic-co-glycolic acid) (PLGA), polyvinyl alcohol (PVA), poly(N-isopropylacrylamide) (PNIPAM), poly(acrylic acid) (PAA), poly(2-oxazoline), polyethylene oxide (PEO) polybutadiene (PB) block copolymers, or a mixture thereof. Even more in particular, the amphiphilic polymer may be a triblock polymer, particularly a poloxamer.

The conductive ink may further comprise a dopant. In particular the dopant may improve the conductivity of the conductive ink. The dopant may be any suitable dopant. For example, the dopant may be a polar solvent, organic acid, inorganic acid, polyol, surfactant, conductive polymer, ionic liquid, or a mixture thereof.

According to one aspect, the dopant may comprise a polar solvent such as, but not limited to, dimethyl sulfoxide (DMSO), ethylene glycol (EG), isopropyl alcohol (IPA), methanol, formamide, dimethylformamide (DMF), N-Methyl-2-pyrrolidone (NMP), or a mixture thereof.

According to one aspect, the dopant may comprise an organic acid such as, but not limited to, p-Toluenesulfonic acid (p-TSA), camphorsulfonic acid (CSA), dodecylbenzenesulfonic acid (DBSA), poly(4-styrenesulfonic acid), ethanesulfonic acid (ESA), heptanesulfonic acid (HSA), or a mixture thereof.

According to one aspect, the dopant may comprise an inorganic acid such as, but not limited to, hydrochloric acid (HCl), sulfuric acid (H₂SO₄), phosphoric acid (H₃PO₄), nitric acid (HNO₃), perchloric acid (HClO₄), formic acid (HCOOH), or a mixture thereof.

According to one aspect, the dopant may comprise a polyol such as, but not limited to, ethylene glycol (EG), glycerol, sorbitol, diethylene glycol (DEG), propylene glycol, or a mixture thereof.

According to one aspect, the dopant may comprise a surfactant such as, but not limited to, polyvinyl alcohol (PVA), Triton X-100, sodium dodecyl sulfate (SDS), polyethylene glycol (PEG), sodium dodecylbenzenesulfonate (SDBS), cetyltrimethylammonium bromide (CTAB), or a mixture thereof.

According to one aspect, the dopant may comprise a conducting polymer such as, but not limited to, polypyrrole (PPy), polyaniline (PANI), polythiophene (PTh), poly(3,4-ethylenedioxythiophene) (PEDOT), polyfluorene (PF), polyacetylene, or a mixture thereof.

According to one aspect, the dopant may comprise an ionic liquid such as, but not limited to, 1-ethyl-3-methylimidazolium bis(trifluoromethylsulfonyl)imide ([EMIM][TFSI]), 1-butyl-3-methylimidazolium tetrafluoroborate ([BMIM][BF4]), 1-ethyl-3-methylimidazolium hexafluorophosphate ([EMIM][PF6]), 1-butyl-3-methylimidazolium hexafluorophosphate ([BMIM][PF6]), 1-ethyl-3-methylimidazolium chloride ([EMIM][CI]), 1-octyl-3-methylimidazolium tetrafluoroborate ([OMIM][BF4]), or a mixture thereof.

The conductive ink may further comprise a redox mediator. For example, the redox mediator may comprise, but is not limited to, Prussian Blue. The redox mediator may also enhance the sensitivity of the conductive ink.

The conductive ink may comprise a suitable amount of the carbon-based material, conducting polymer, viscoelastic polymer, amphiphilic polymer, and optionally, dopant and/or redox mediator.

According to a particular aspect, the conductive ink may comprise: 5-50 wt % of carbon-based material, 30-90 wt % of conducting polymer, 5-50 wt % of viscoelastic polymer, 0.1-30 wt % of amphiphilic polymer. In particular, the conductive ink may comprise: 10-30 wt % of carbon-based material. In particular, the conductive ink may comprise: 30-60 wt % of conducting polymer. In particular, the conductive ink may comprise: 5-30 wt % of viscoelastic polymer. In particular, the conductive ink may comprise: 0.1-20 wt % of amphiphilic polymer.

According to another particular aspect, when the conductive ink comprises a dopant and redox mediator, the conductive ink may comprise: 5-50 wt % viscoelastic polymer based on the total weight of the conductive ink; 0.1-30 wt % amphiphilic polymer based on the total weight of the conductive ink; and the remaining weight of the conductive ink comprises the combined weight of the carbon-based material, conducting polymer, dopant and redox mediator.

For example, the conductive ink may comprise carbon-based material, conducting polymer, viscoelastic polymer, amphiphilic polymer, dopant and redox mediator in weight % based on the total weight of the conductive ink as shown below in Table 1. In particular, by adjusting the amount of viscoelastic polymer to amphiphilic polymer comprised in the conductive ink, the hydrophilicity of the conductive ink may be adjusted and controlled.

TABLE 2
Composition of conductive ink based
on total weight of conductive ink

| | | Carbon-based material:conducting |
|---|---|---|
| WPU (wt %) | F127 (wt %) | polymer:dopant:redox mediator (wt %) |
| 5 | 0.1-30 | 65-94.9 |
| 10 | 0.1-30 | 60-89.9 |
| 20 | 0.1-30 | 50-79.9 |
| 50 | 0.1-30 | 20-49.9 |

The conductive ink may comprise a porous structure following annealing. In particular, the annealed conductive ink may comprise a nanoporous structure. For example, annealing results in the removal of the dominant aqueous medium of the conductive ink, thereby resulting in the formation of a porous network. In this way, the conductive ink may provide a 3D matrix for hosting bio-recognition elements, resulting in higher electrode active surface area for improved sensitivity for detection.

According to a second aspect, there is provided an electrode for an electrochemical sensor comprising a substrate and a stretchable conductive ink. The stretchable conductive ink may be as described above in relation to the first aspect.

According to a second aspect, there is provided an electrode for an electrochemical sensor comprising: a substrate; and a conductive ink according to the first aspect provided on a surface of the substrate. The electrode may be a stretchable electrode.

The conductive ink may be provided on the surface of the substrate by any suitable means. In particular, the conductive ink may be provided on a surface of the substrate by, but not limited to, screen-printing, ink dispensing, gravure printing, blade coating, or a combination thereof.

The substrate may be any suitable substrate. According to a particular aspect, the substrate may be elastomeric. For example, the substrate may comprise, but is not limited to, styrene-ethylene-butylene-styrene (SEBS), thermoplastic polyurethane (TPU), polydimethylsiloxane (PDMS), polyurethane (PU), ethylene propylene diene monomer (EPDM), polyethylene terephthalate glycol (PETG), polyimide (PI), polysiloxane (silicone), polyethylene (PE), polypropylene (PP), polyvinyl chloride (PVC), polystyrene (PS), polyethylene terephthalate (PET), poly(methyl methacrylate) (PMMA), polyvinyl acetate (PVA), polyisoprene, polybutadiene, natural rubber, styrene butadiene rubber (SBR), nitrile rubber (NBR), ethylene propylene diene monomer (EPDM), chloroprene rubber (Neoprene), butyl rubber (IIR), polysiloxane (silicone), fluoroelastomers (FKM), or a mixture thereof.

Having now generally described the invention, the same will be more readily understood through reference to the following example which is provided by way of illustration, and is not intended to be limiting.

### EXAMPLE

### Preparation of Substrate

A styrene-ethylene-butylene-styrene (SEBS) substrate was prepared via hot-pressing SEBS pellets (Tuftec H1062) to produce a film having a thickness of about 100 μm. SEBS is stretchable and may be elongated up on 670%.

### Preparation of Conductive Ink

Several stretchable conductive inks were prepared by mixing 1 g graphite (Timcal Timrex KS6), 3 ml PEDOT:PSS (Heraeus Clevios PH1000), 100 mg Prussian Blue, 0.15 ml DMSO, waterborne polyurethane (WPU) and poly(ethylene oxide)-poly(propylene oxide)-poly(ethylene oxide) (PEO-PPO-PEO) (Pluronic® F127) (0.02 g/ml in distilled water) to form a mixture. Different mixtures were prepared by varying the amounts of WPU and F127 as shown in Table 2.

TABLE 2
Composition of WPU and F127 in mixture
to prepare conductive ink

| WPU (wt %) | F127 (wt %) |
|---|---|
| 50 | 0 |
| 40 | 10 |
| 30 | 20 |
| 20 | 30 |

The mixtures were each asymmetrically centrifuged at 2000 rpm for 5 min to produce the respective conductive ink.

### Preparation of Electrodes

The prepared SEBS substrates were screen printed using a DEK 265 screen printer. Firstly, the SEBS substrates were treated under oxygen plasma conditions for 5 min. Next, silver (Dycotec Materials SIP-2006) was screen-printed and annealed at 120° C. for 10 min. The printed substrates were UV-ozone treated for 2 min at room temperature to render the surface hydrophilic before screen printing a layer of the conductive ink. The conductive ink was annealed at 120° C. for 10 min to form the electrodes. After annealing, the conductive ink had a porous structure providing a 3D matrix.

### Stretch Test

A simple stretch test was conducted to verify the change in resistance of the stretchable conductive ink under repeated stretching of 1000 cycles. The prepared conductive inks were coated as a film on SEBS on an area of 2 cm×10 cm. The film was subjected to a 30% stretch between 2 points, spaced 5 cm apart. As explained above, the different conductive inks comprised the same amounts of graphite, PEDOT:PSS, DMSO and Prussian Blue, but varying amounts of WPU and F127 was used for preparing the inks, as shown in Table 2 above.

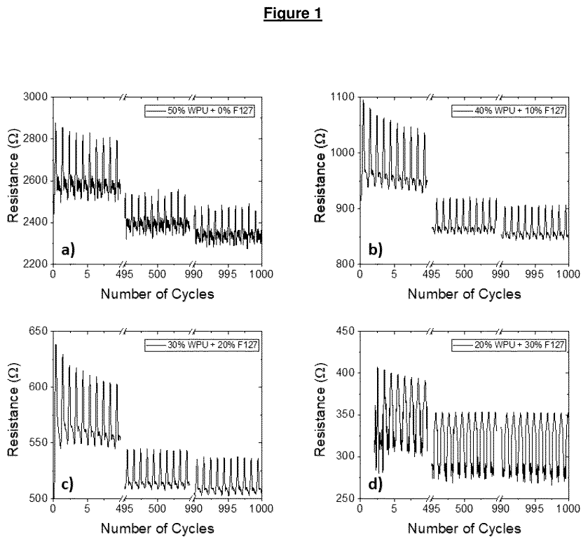

FIGS. 1(a) to (d) show the changes in resistance of the conductive inks based on different amounts of WPU and F127 added. As shown in FIGS. 1(a)-(d), there is an approximate 9-10% drop in resistance for all samples by 500 cycles, which stabilises to 1000 cycles. The drop in resistance may be attributed to the fracturing of the bulk when the conducting matrix is being pulled apart. In fact, a lower WPU content produces lower resistance, which can be attributed to the insulating properties of the viscoelastic polymer.

### Hydrophilicity

F127 imparts hydrophilicity to the stretchable conductive ink. As a simple test, microvolume of DI water (~10 μL) was dropped onto the surface of the conductive ink. For a film without any F127, the surface appeared rather hydrophobic, although WPU is known to be hydrophilic. However, the presence of any amount of F127 tested rendered the surface very hydrophilic. In fact, the surface was so hydrophilic that the film absorbed the DI water into its bulk easily. Thus, the conductive ink formed was remarkably absorbing.

### Electrochemical Sensors

To demonstrate the application of the electrodes, electrochemical glucose sensors were fabricated based on the different composition of WPU and F127 according to Table 2. For comparison, commercially available DropSens DS-710 (rigid substrate) was used to benchmark results obtained.

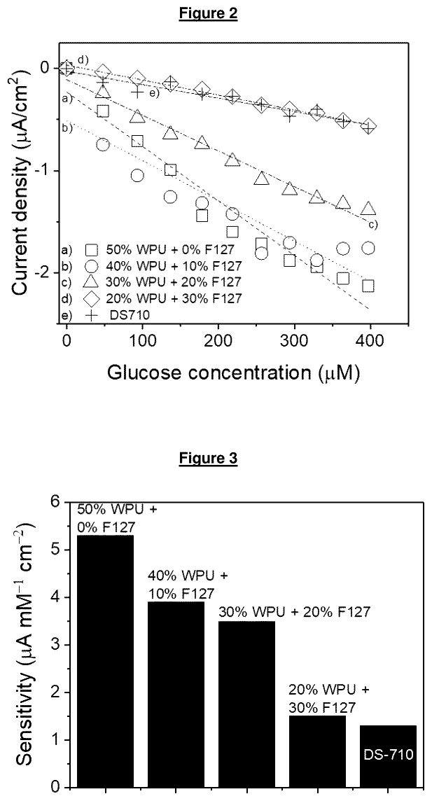

FIG. 2 provides the current density observed when the electrodes were used as glucose sensors using an amperometric method under unstretched conditions, while FIG. 3 provides the sensitivity of the corresponding sensors. FIG. 3 was derived based on the slope of the lines in FIG. 2.

As can be seen in FIG. 2, a linear relationship between current density and glucose concentration can be observed. Further, as can be seen from FIG. 3, the electrodes comprising the conductive inks with a higher WPU content (>30%) all demonstrated more sensitivity than DropSens DS-710, while sensors with conductive ink comprising 20% WPU and 30% F127 appeared to be comparable to its commercial counterpart.

### Structure

A comparison of the structures of annealed conducting ink and commercially available DropSens DS-710 was done by scanning electron microscope (SEM). The conducting ink was formed from 18 wt % graphite, 54.5 wt % PEDOT:PSS, 1.8 wt % Prussian Blue, 2.7 wt % DMSO, 22.7 wt % WPU (note all % are rounded and hence not equaling to 100%).

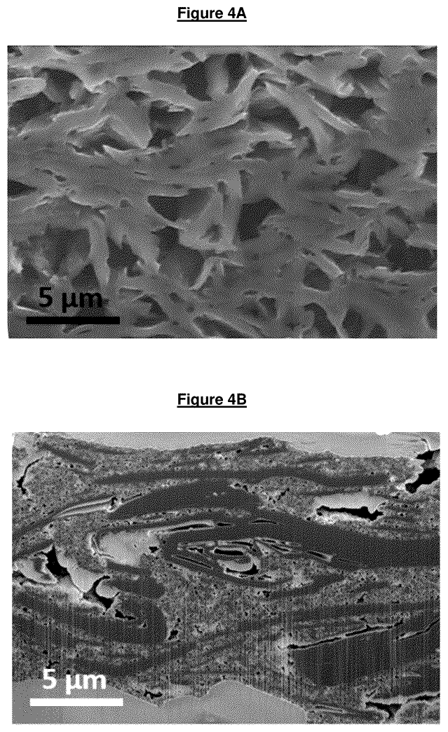

The SEM images of the cross-sectional printed electrode comprising the conductive ink and commercially available DropSens DS-710 is shown in FIG. 4A and FIG. 4B respectively. It can be seen that the electrode comprising the conductive ink had a nanoporous structure, thereby providing 3D matrix to host elements resulting in higher electrode active surface area for improved detection sensitivity. In contrast, the commercially available electrode had a compact network.

Whilst the foregoing description has described exemplary embodiments, it will be understood by those skilled in the technology concerned that many variations may be made without departing from the present invention.

1. A stretchable conductive ink comprising:
a carbon-based material;
a conducting polymer;
a viscoelastic polymer; and
an amphiphilic polymer,
wherein the conductive ink is hydrophilic.

2. The conductive ink according to claim 1, further comprising a dopant for improving conductivity of the conductive ink.

3. The conductive ink according to claim 2, wherein the dopant is a polar solvent, organic acid, inorganic acid, polyol, surfactant, conductive polymer, ionic liquid, or a mixture thereof.

4. The conductive ink according to claim 2, wherein the dopant is dimethyl sulfoxide (DMSO).

5. The conductive ink according to claim 1, wherein the carbon-based material comprises graphite, or a mixture thereof.

6. The conductive ink according to claim 1, wherein the conducting polymer comprises a conjugated polymer.

7. The conductive ink according to claim 6, wherein the conjugated polymer is: poly(3,4-ethylenedioxythiophene) polystyrene sulfonate (PEDOT:PSS).

8. The conductive ink according to claim 1, wherein the viscoelastic polymer is a viscoelastic secondary polymer.

9. The conductive ink according to claim 8, wherein the viscoelastic polymer is: waterborne polyurethane.

10. The conductive ink according to claim 1, wherein the amphiphilic polymer comprises an amphiphilic block copolymer.

11. The conductive ink according to claim 10, wherein the amphiphilic block copolymer comprises a triblock copolymer.

12. The conductive ink according to claim 1, wherein the amphiphilic copolymer comprises poloxamer.

13. The conductive ink according to claim 1, further comprising a redox mediator.

14. An electrode for an electrochemical sensor comprising a substrate and a conductive ink according to claim 1 provided on a surface of the substrate.

15. The electrode according to claim 14, wherein the conductive ink is screen-printed on a surface of the substrate.

16. The electrode according to claim 14, wherein the electrode is stretchable.

17. The electrode according to claim 14, wherein the substrate is elastomeric.
